(19) United States
(12) Patent Application Publication
(10) Pub. No.: US 2004/0149174 A1
(43) Pub. Date: Aug. 5, 2004

(54) Accelerating admixture for concrete

(75) Inventors: Stephen A. Farrington, University Heights, OH (US); Bruce J. Christensen, Solon, OH (US)

Correspondence Address: JOSEPH G CURATOLO, ESQ., RENNER KENNER GREIVE BOBAK TAYLOR & WEBER, 24500 CENTER RIDGE ROAD, SUITE 280, WESTLAKE, OH, 44145, US

(73) Assignee: MBT Holding AG, Zurich (CH)

(21) Appl. No.: 10/358,585

(22) Filed: Feb. 5, 2003

(51) Int. Cl. C04B 7/00; C04B 16/00; C04B 24/00; C04B 24/10

(52) U.S. Cl. 106/802; 106/808; 106/823; 524/5

(57) ABSTRACT

A cold-weather admixture composition that accelerates the setting time and strength development of cementitious compositions is provided which comprises the components of a soluble inorganic salt having freezing point depressing properties, an inorganic early set and strength accelerator, a polycarboxylate high range water reducing dispersant, and an organic set accelerator. With lower dosages of dispersant than those disclosed in the prior art the admixture composition provides to concrete increased dispersant performance and acceleration of setting time and strength development.

### BACKGROUND

The placement of concrete under cold-weather conditions calls for special considerations to ensure proper hardening and strength development. Committee 306 of the American Concrete Institute defines cold-weather conditions as three consecutive days where two conditions must occur—the average daily air temperature is less than 5° C. and the air temperature does not exceed 10° C. for more than twelve hours in any 24-hour period. Under cold-weather conditions, the concrete has to be protected to avoid damage due to freezing at early ages, ensure that adequate strength will be realized for removal of formwork, avoid thermal cracking, and ensure that the structure will meet its service life requirements. Protective measures include 1) heating of the concrete materials, 2) use of Type III cement, 3) use of additional cement, 4) use of chemical admixtures that accelerate setting and strength development, 5) use of protective insulation, and 6) enclosing and heating the area in which the concrete will be placed.

Over the past ten years, developments in the field of chemical admixtures for use in placement of concrete under sub-freezing conditions have been reported. Many of these studies have focused on a group of chemicals that both lower the freezing point of the pore water of concrete and accelerate the hydration of cement, while other studies have focused on materials that provide acceleration without freezing point reduction. In the majority of the studies presented in the literature, the concrete was batched at 20° C. and then cured at subfreezing temperatures, and strength development was compared to concrete that was cured at 20° C. Under these testing conditions, the results may be misleading, as setting and strength development are governed by concrete temperature, and the effect of the ambient conditions on the lowering of the concrete temperature is dependent on the concrete mass and specimen geometry. In one study, the concrete was batched with frozen materials, and strength development in the concrete with the antifreeze admixtures developed poorly.

Dispersants are substances that improve the flow characteristics of the cement paste by breaking up cement agglomerates and freeing the water, thus providing a paste of lower viscosity and allowing desirable flow conditions to be obtained. Superplasticizers such as sulfonated melamine formaldehyde condensate (SMF) and naphthalene sulfonated formaldehyde condensate (BNS) are commonly used as dispersants. However, these compounds are not as efficient as polycarboxylate dispersants that have been introduced to the concrete industry more recently. The standard rule in the industry that is used to compare dispersant performance of polycarboxylates versus sulfonated naphthalene formaldehyde condensates is that the polycarboxylates are three times more efficient, on an equivalent solids basis.

It is important that dispersants are used in concrete in situations where strength and durability are involved, as dispersants are a necessary component in high strength and high durability concretes. Due to the use of low water amounts in the high performance concretes, high dispersant amounts are sometimes necessary to achieve workable concretes. High BNS levels can lead to undesirable retardation of set and may not provide the required workability retention over time.

It is desirable to provide an admixture with a polycarboxylate high range water reducing dispersant that is at least several times more efficient as a cement or concrete dispersant than the traditional materials like BNS and SMF. Improving efficiency reduces the amount of material required to achieve a desired level of concrete workability or water reduction. With respect to the presently used dispersants, BNS and SMF, it is also desirable to improve the setting time of the concrete (accelerating) while maintaining the desired strength development.

U.S. Pat. No. 5,176,753 discloses a chloride-free admixture for use as a cold weather concrete set accelerator which comprises a soluble inorganic salt having freezing point depressant properties, a naphthalene sulphonate formaldehyde condensate or sulphonated melamine formaldehyde condensate, inorganic early set and strength accelerator, and optionally an organic set accelerator.

U.S. Pat. No. 5,840,114 discloses a high early strength admixture for precast hydraulic cement which comprises a calcium salt and a copolymer having a carbon containing backbone to which are attached cement-anchoring members, such as carboxyl groups, and to which are also attached oxyalkylene pendant groups by linkages selected from the group consisting of amide and imide members.

### SUMMARY

An admixture composition that accelerates the setting time and strength development of cementitious compositions under cold weather conditions is provided which comprises the components of soluble inorganic salt having freezing point depressing properties, inorganic early set and strength accelerator, polycarboxylate high range water reducing dispersant, and organic set accelerator.

A cementitious composition is provided that comprises hydraulic cement and a cold weather admixture composition, wherein the admixture composition comprises soluble inorganic salt having freezing point depressing properties, inorganic early set and strength accelerator, polycarboxylate high range water reducing dispersant, and organic set accelerator.

A method of making a cementitious composition is provided which comprises forming a mixture of water, hydraulic cement and a cold weather admixture composition wherein the admixture composition comprises soluble inorganic salt having freezing point depressing properties, inorganic early set and strength accelerator, polycarboxylate high range water reducing dispersant, and organic set accelerator.

A cold weather admixture composition for cementitious compositions is provided which comprises soluble inorganic salt having freezing point depressing properties, inorganic early set and strength accelerator, a polycarboxylate high range water reducing dispersant; wherein the polycarboxylate high range water reducing dispersant has the general structure shown below:

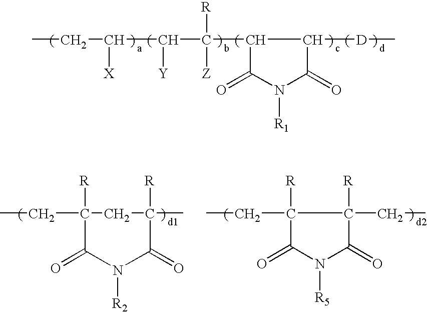

wherein in Formula (III):

D=a component selected from the group consisting of the structure d1, the structure d2, and mixtures thereof;

X=H, CH₃, C₂ to C₆ Alkyl, Phenyl, p-Methyl Phenyl, or Sulfonated Phenyl;

Y=H or —COOM;

R=H or CH₃;

Z=H, —SO₃M, —PO₃M, —COOM, —O(CH₂)ₙOR₃ where n=2 to 6,

—COOR₃, or —(CH₂)ₙOR₃ where n=0 to 6,

—CONHR₃, —CONHC(CH₃)₂ CH₂SO₃M, —COO(CHR₄)ₙOH where n=2 to 6, or —O(CH₂)ₙOR₄ wherein n=2 to 6;

R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;

R₄=H, Methyl, C₂ to about C₆ Alkyl, or about C₆ to about C₁₀ aryl;

M=H, Alkali Metal, Alkaline Earth Metal, Ammonium, Amine, triethanol amine, Methyl, or C₂ to about C₆ Alkyl;

a=0 to about 0.8;

b=about 0.2 to about 1.0;

C=0 to about 0.5;

d=0 to about 0.5; and

wherein a, b, c, and d represent the mole fraction of each unit and the sum of a, b, c, and d is 1.0; and an organic set accelerator.

A cementitious composition is provided which comprises hydraulic cement and a cold weather admixture composition, said admixture composition comprising: soluble inorganic salt having freezing point depressing properties, inorganic early set and strength accelerator, a polycarboxylate high range water reducing dispersant; wherein the high range water reducing dispersant is a polycarboxylate high range water reducing dispersant and has the general structure shown below:

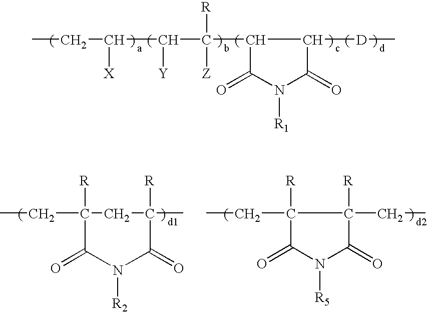

wherein in Formula (III):

D=a component selected from the group consisting of the structure d1, the structure d2, and mixtures thereof;

X=H, CH₃, C₂ to C₆ Alkyl, Phenyl, p-Methyl Phenyl, or Sulfonated Phenyl;

Y=H or —COOM;

R=H or CH₃;

Z=H, —SO₃M, —PO₃M, —COOM, —O(CH₂)ₙOR₃ where n=2 to 6,

—COOR₃, or —(CH₂)ₙOR₃ where n=0 to 6,

—CONHR₃, —CONHC(CH₃)₂ CH₂SO₃M, —COO(CHR₄)ₙOH where n=2 to 6, or —O(CH₂)ₙOR₄ wherein n=2 to 6;

R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;

R₄=H, Methyl, C₂ to about C₆ Alkyl, or about C₆ to about C₁₀ aryl;

M=H, Alkali Metal, Alkaline Earth Metal, Ammonium, Amine, triethanol amine, Methyl, or C₂ to about C₆ Alkyl;

a=0 to about 0.8;

b=about 0.2 to about 1.0;

c=0 to about 0.5;

d=0 to about 0.5; and

wherein a, b, c, and d represent the mole fraction of each unit and the sum of a, b, c, and d is 1.0; and an organic set accelerator.

### DETAILED DESCRIPTION

A cold weather admixture composition for cementitious compositions is provided, as well as a novel cementitious composition containing such an admixture composition and a method for preparing the cementitious composition.

The amount of polycarboxylate high range water reducing dispersant used in the present admixture composition falls below the level of what would be expected in the prior art to achieve similar results of dispersion performance. The standard rule observed in the prior art to compare the performance of naphthalene sulfonate formaldehyde condensate with that of polycarboxylate high range water reducing dispersants is that the polycarboxylate high range water reducing dispersants are three times more efficient on an equivalent solids basis. Unexpectedly, the polycarboxylate high range water reducing dispersant of the present admixture composition provides equivalent dispersant results with only about one seventh the amount of naphthalene sulfonate formaldehyde condensate disclosed in the prior art, instead of one half to one third. Additionally, the present admixture containing the polycarboxylate high range water reducing dispersant is an improved accelerator of setting time and early strength development as compared to the admixture containing naphthalene sulfonate formaldehyde condensate.

The addition of the admixture to cementitious materials protects the cementitious material from freezing and allows the cementitious material to set and gain strength under cold weather conditions. The lowering of the water to cement ratio in the cementitious materials with the admixture improves the setting and strength development of cementitious materials at low curing temperatures.

While not being limited to theory it is thought that there is a negative synergy between the accelerator package (soluble inorganic salt, inorganic early set and strength accelerator, and organic set accelerator) and the naphthalene sulfonate formaldehyde condensate which inhibits the performance of the accelerator package and dispersant. When the naphthalene sulfonate formaldehyde condensate is replaced with a polycarboxylate high range water reducing dispersant this negative synergy is removed and the improved performance of the polycarboxylate high range water reducing dispersant and accelerator package occurs.

Polycarboxylate high range water reducing dispersants include polymers with a carbon backbone with pendant side chains, wherein at least a portion of the side chains are attached to the backbone through a carboxyl group or an ether group. Polycarboxylate high range water reducing dispersants are very effective at dispersing and reducing the water content in hydraulic cementitious compositions. These dispersants operate by binding to a cement particle and developing both electrostatic and steric repulsive forces, thereby keeping the particles apart, resulting in a more fluid system.

The term polycarboxylate high range water reducing dispersant used throughout this specification refers to polymers with a carbon backbone with pendant side chains, wherein at least a portion of the side chains are attached to the backbone through a carboxyl group or an ether group. The term dispersant is also meant to include those chemicals which also function as a plasticizer, water reducer, fluidizer, antiflocculating agent, or superplasticizer for cementitious compositions. Examples of polycarboxylate high range water reducing dispersants can be found in U.S. Pat. No. 6,267,814, U.S. Pat. No. 6,290,770, U.S. Pat. No. 6,310,143, U.S. Pat. No. 6,187,841, U.S. Pat. No. 5,158,996, U.S. Pat. No. 6,008,275, U.S. Pat. No. 6,136,950, U.S. Pat. No. 6,284,867, U.S. Pat. No. 5,609,681, U.S. Pat. No. 5,494,516; U.S. Pat. No. 5,674,929, U.S. Pat. No. 5,660,626, U.S. Pat. No. 5,668,195, U.S. Pat. No. 5,661,206, U.S. Pat. No. 5,358,566, U.S. Pat. No. 5,162,402, U.S. Pat. No. 5,798,425, U.S. Pat. No. 5,612,396, U.S. Pat. No. 6,063,184, and U.S. Pat. No. 5,912,284, U.S. Pat. No. 5,840,114, U.S. Pat. No. 5,753,744, U.S. Pat. No. 5,728,207, U.S. Pat. No. 5,725,657, U.S. Pat. No. 5,703,174, U.S. Pat. No. 5,665,158, U.S. Pat. No. 5,643,978, U.S. Pat. No. 5,633,298, U.S. Pat. No. 5,583,183, and U.S. Pat. No. 5,393,343, which are all incorporated herein by reference. In one embodiment the admixture composition contains about 0.4% to about 15% polycarboxylate high range water reducing dispersant based on the total dry (active) weight of the admixture composition components. In another embodiment the admixture composition contains about 1% to about 6% polycarboxylate high range water reducing dispersant based on the total dry (active) weight of the admixture composition components. In a further embodiment a cementitious composition contains about 0.01% to about 0.2% high range water reducing dispersant by weight of cementitious binder.

The dispersants used in the admixture composition can be at least one of the dispersant formulas a) through k):

a) a dispersant of Formula (I):

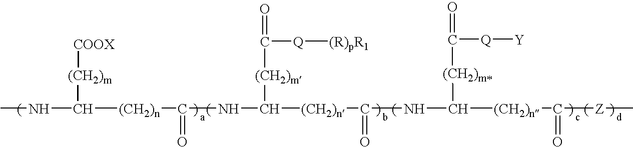

wherein in Formula (I)

X is at least one of hydrogen, an alkali earth metal ion, an alkaline earth metal ion, ammonium ion, or amine;

R is at least one of C₁ to C₆ alkyl(ene) ether or mixtures thereof or C₁ to C₆ alkyl(ene) imine or mixtures thereof;

Q is at least one of oxygen, NH, or sulfur;

p is a number from 1 to about 300 resulting in at least one of a linear side chain or branched side chain;

R₁ is at least one of hydrogen, C₁ to C₂₀ hydrocarbon, or functionalized hydrocarbon containing at least one of —OH, —COOH, an ester or amide derivative of —COOH, sulfonic acid, an ester or amide derivative of sulfonic acid, amine, or epoxy;

Y is at least one of hydrogen, an alkali earth metal ion, an alkaline earth metal ion, ammonium ion, amine, a hydrophobic hydrocarbon or polyalkylene oxide moiety that functions as a defoamer;

m, m′, m″, n, n′, and n″ are each independently 0 or an integer between 1 and about 20;

Z is a moiety containing at least one of i) at least one amine and one acid group, ii) two functional groups capable of incorporating into the backbone selected from the group consisting of dianhydrides, dialdehydes, and di-acid-chlorides, or iii) an imide residue; and

wherein a, b, c, and d reflect the mole fraction of each unit wherein the sum of a, b, c, and d equal one, wherein a, b, c, and d are each a value greater than or equal to zero and less than one, and at least two of a, b, c, and d are greater than zero;

b) a dispersant of Formula (II):

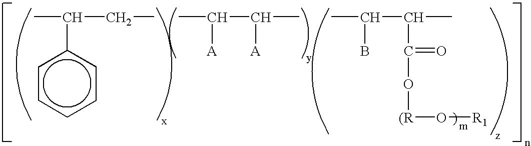

wherein in Formula (II):

A is COOM or optionally in the “y” structure an acid anhydride group (—CO—O—CO—) is formed in place of the A groups between the carbon atoms to which the A groups are bonded to form an anhydride;

B is COOM

M is hydrogen, a transition metal cation, the residue of a hydrophobic polyalkylene glycol or polysiloxane, an alkali metal ion, an alkaline earth metal ion, ferrous ion, aluminum ion, (alkanol)ammonium ion, or (alkyl)ammonium ion;

R is a C₂₋₆ alkylene radical;

R1 is a C₁₋₂₀ alkyl, C₆₋₉ cycloalkyl, or phenyl group;

x, y, and z are a number from 0.01 to 100;

m is a number from 1 to 100; and

n is a number from 10 to 100;

c) a dispersant comprising at least one polymer or a salt thereof having the form of a copolymer of

i) a maleic anhydride half-ester with a compound of the formula RO(AO)ₘH, wherein R is a C₁-C₂₀ alkyl group, A is a C₂₋₄ alkylene group, and m is an integer from 2-16; and

ii) a monomer having the formula CH₂═CHCH₂—(OA)ₙOR, wherein n is an integer from 1-90 and R is a C₁₋₂₀ alkyl group;

d) a dispersant obtained by copolymerizing 5 to 98% by weight of an (alkoxy)polyalkylene glycol mono(meth)acrylic ester monomer (a) represented by the following general formula (1):

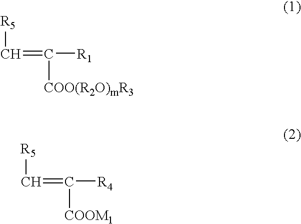

wherein R₁ stands for hydrogen atom or a methyl group, R₂O for one species or a mixture of two or more species of oxyalkylene group of 2 to 4 carbon atoms, providing two or more species of the mixture may be added either in the form of a block or in a random form, R₃ for a hydrogen atom or an alkyl group of 1 to 5 carbon atoms, and m is a value indicating the average addition mol number of oxyalkylene groups that is an integer in the range of 1 to 100, 95 to 2% by weight of a (meth)acrylic acid monomer (b) represented by the above general formula (2), wherein R₄ and R₅ are each independently a hydrogen atom or a methyl group, and M₁ for a hydrogen atom, a monovalent metal atom, a divalent metal atom, an ammonium group, or an organic amine group, and 0 to 50% by weight of other monomer (c) copolymerizable with these monomers, provided that the total amount of (a), (b), and (c) is 100% by weight;

e) a graft polymer that is a polycarboxylic acid or a salt thereof, having side chains derived from at least one species selected from the group consisting of oligoalkyleneglycols, polyalcohols, polyoxyalkylene amines, and polyalkylene glycols;

f) a reaction product of component A, optionally component B, and component C;

wherein each component A is independently a nonpolymeric, multi-functional moiety or combination of mono or multifunctional moieties that adsorbs onto a cementitious particle, and contains at least one residue derived from a first component selected from the group consisting of phosphates, phosphonates, phosphinates, hypophosphites, sulfates, sulfonates, sulfinates, alkyl trialkoxy silanes, alkyl triacyloxy silanes, alkyl triaryloxy silanes, borates, boronates, boroxines, phosphoramides, amines, amides, quaternary ammonium groups, carboxylic acids, carboxylic acid esters, alcohols, carbohydrates, phosphate esters of sugars, borate esters of sugars, sulfate esters of sugars, salts of any of the preceding moieties, and mixtures thereof;

wherein component B is an optional moiety, where if present, each component B is independently a nonpolymeric moiety that is disposed between the component A moiety and the component C moiety, and is derived from a second component selected from the group consisting of linear saturated hydrocarbons, linear unsaturated hydrocarbons, saturated branched hydrocarbons, unsaturated branched hydrocarbons, alicyclic hydrocarbons, heterocyclic hydrocarbons, aryl, phosphoester, nitrogen containing compounds, and mixtures thereof; and

wherein component C is at least one moiety that is a linear or branched water soluble, nonionic polymer substantially non-adsorbing to cement particles, and is selected from the group consisting of poly(oxyalkylene glycol), poly(oxyalkylene amine), poly(oxyalkylene diamine), monoalkoxy poly(oxyalkylene amine), monoaryloxy poly(oxyalkylene amine), monoalkoxy poly(oxyalkylene glycol), monoaryloxy poly(oxyalkylene glycol), poly(vinyl pyrrolidones), poly(methyl vinyl ethers), poly(ethylene imines), poly(acrylamides), polyoxazoles, and mixtures thereof; and

g) a dispersant of Formula (III):

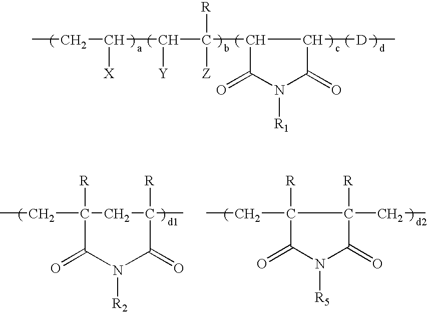

wherein in Formula (III):

D=a component selected from the group consisting of the structure d1, the structure d2, and mixtures thereof;

X=H, CH₃, C₂ to C₆ Alkyl, Phenyl, p-Methyl Phenyl, or Sulfonated Phenyl;

Y=H or —COOM;

R=H or CH₃;

Z=H, —SO₃M, —PO₃M, —COOM, —O(CH₂)ₙOR₃ where n=2 to 6,

—COOR₃, or —(CH₂)ₙOR₃ where n=0 to 6,

—CONHR₃, —CONHC(CH₃)₂ CH₂SO₃M, —COO(CHR₄)ₙOH where n=2 to 6, or —O(CH₂)ₙOR₄ wherein n=2 to 6;

R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;

R₄=H, Methyl, C₂ to about C₆ Alkyl, or about C₆ to about C₁₀ aryl;

M=H, Alkali Metal, Alkaline Earth Metal, Ammonium, Amine, triethanol amine, Methyl, or C₂ to about C₆ Alkyl;

a=0 to about 0.8;

b about 0.2 to about 1.0;

c=0 to about 0.5;

d=0 to about 0.5; and

wherein a, b, c, and d represent the mole fraction of each unit and the sum of a, b, c, and d is 1.0;

h) a dispersant of Formula (IV):

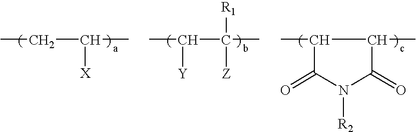

wherein in Formula (IV):

the “b” structure is one of a carboxylic acid monomer, an ethylenically unsaturated monomer, or maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage;

X=H, CH₃, C₂ to C₆ Alkyl, Phenyl, p-Methyl Phenyl, p-Ethyl Phenyl, Carboxylated Phenyl, or Sulfonated Phenyl;

Y=H, —COOM, —COOH, or W;

W=a hydrophobic defoamer represented by the formula R₅O—(CH₂CH₂O)ₛ—(CH₂C(CH₃)HO)ₜ—(CH₂CH₂O)ᵤ where s, t, and u are integers from 0 to 200 with the proviso that t>(s+u) and wherein the total amount of hydrophobic defoamer is present in an amount less than about 10% by weight of the polycarboxylate dispersant;

Z=H, —COOM, —O(CH₂)ₙOR₃ where n=2 to 6, —COOR₃, —(CH₂)ₙOR₃ where n=0 to 6, or —CONHR₃;

R₁ H, or CH₃;

R₂, R₃, are each independently a random copolymer of oxyethylene units and oxypropylene units of the general formula —CH(R₁)CH₂O)ₘR₄ where m=10 to 500 and wherein the amount of oxyethylene in the random copolymer is from about 60% to 100% and the amount of oxypropylene in the random copolymer is from 0% to about 40%;

R₄=H, Methyl, or C₂ to C₈ Alkyl;

R₅=C₁ to C₁₈ alkyl or C₆ to C₁₈ alkyl aryl;

M=Alkali Metal, Alkaline Earth Metal, Ammonia, Amine, monoethanol amine, diethanol amine, triethanol amine, morpholine, imidazole;

a=0.01-0.8;

b=0.2-0.99;

c=0-0.5; and

wherein a, b, c represent the mole fraction of each unit and the sum of a, b, and c, is 1;

i) a random copolymer corresponding to the following Formula (V) in free acid or salt form having the following monomer units and numbers of monomer units:

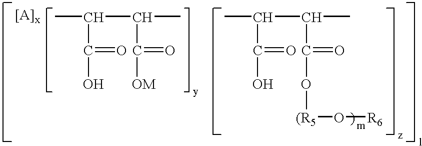

wherein A is selected from the moieties (i) or (ii)

(i) —CR₁R₂—CR₃R₄—

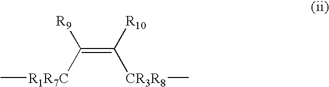

wherein R₁ and R₃ are selected from substituted benzene, C₁₋₈ alkyl, C₂₋₈ alkenyl, C₂₋₈ alkylcarbonyl, C₁₋₈ alkoxy, carboxyl, hydrogen, and a ring, R₂ and R₄ are selected from the group consisting of hydrogen and C₁₋₄ alkyl, wherein R₁ and R₃ can together with R₂ and/or R₄ when R₂ and/or R₄ are C₁₋₄ alkyl form the ring;

R₇, R₈, R₉, and R₁₀ are individually selected from the group consisting of hydrogen, C₁₋₆ alkyl, and a C₂₋₈ hydrocarbon chain, wherein R₁ and R₃ together with R₇ and/or R₈, R₉, and R₁₀ form the C₂₋₈ hydrocarbon chain joining the carbon atoms to which they are attached, the hydrocarbon chain optionally having at least one anionic group, wherein the at least one anionic group is optionally sulfonic;

M is selected from the group consisting of hydrogen, and the residue of a hydrophobic polyalkylene glycol or a polysiloxane, with the proviso that when A is (ii) and M is the residue of a hydrophobic polyalkylene glycol, M must be different from the group —(R₁₀)ₘR₆;

R₅ is a C₂₋₈ alkylene radical;

R₆ is selected from the group consisting of C₁₋₂₀ alkyl, C₆₋₉ cycloalkyl and phenyl;

n, x, and z are numbers from 1 to 100;

y is 0 to 100;

m is 2 to 1000;

the ratio of x to (y+z) is from 1:10 to 10:1 and the ratio of y:z is from 5:1 to 1:100;

j) a copolymer of oxyalkyleneglycol-alkenyl ethers and unsaturated dicarboxylic acids, comprising:

i) 0 to 90 mol % of at least one component of the formula 3a or 3b:

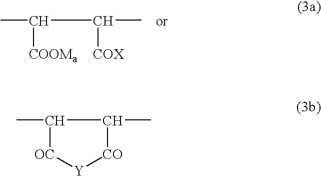

wherein M is a hydrogen atom, a mono- or divalent metal cation, an ammonium ion or an organic amine residue, a is 1, or when M is a divalent metal cation a is ½;

wherein X is —OMₐ,

—O—(CₘH₂ₘO)ₙ—R₁ in which R¹ is a hydrogen atom, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄alkyl, or sulphonic substituted aryl radical containing 6 to 14 carbon atoms, m is 2 to 4, and n is 0 to 100,

—NHR₂, —N(R²)₂ or mixtures thereof in which R²═R¹ or —CO—NH₂; and

wherein Y is an oxygen atom or —NR²;

ii) 1 to 89-mol % of components of the general formula 4:

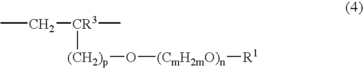

wherein R₃ is a hydrogen atom or an aliphatic hydrocarbon radical containing from 1 to 5 carbon atoms, p is 0 to 3, and R₁ is hydrogen, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₄ alkyl, or sulfonic substituted aryl radical containing 6 to 14 carbon atoms, m is 2 to 4, and n is 0 to 100, and

iii) 0.1 to 10 mol % of at least one component of the formula 5a or 5b:

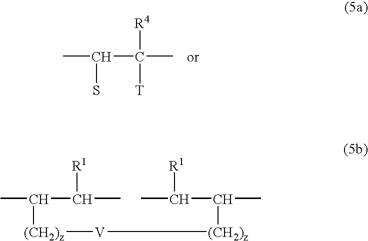

wherein S is a hydrogen atom or —COOMₐ or —COOR₅, T is —COOR₅, —W—R₇, —CO—[—NH—(CH2)3)—]ₛ—W—R₇, —CO—O—(CH₂)_{z}—W—R₇, a radical of the general formula:

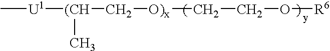

or —(CH₂)_{z}—V—(CH₂)_{z}—CH═CH—R₁, or when S is —COOR₅ or —COOMₐ, U₁ is —CO—NHM-, —O— or —CH₂O, U₂ is —NH—CO—, —O— or —OCH₂, V is —O—CO—C₆H₄—CO—O— or —W—, and W is

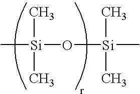

R4 is a hydrogen atom or a methyl radical, R5 is an aliphatic hydrocarbon radical containing 3 to 20 carbon atoms, a cycloaliphatic hydrocarbon radical containing 5 to 8 carbon atoms or an aryl radical containing 6 to 14 carbon atoms, R₆═R₁ or

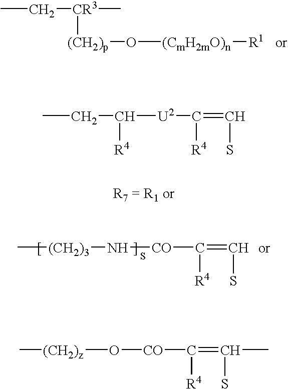

r is 2 to 100, s is 1 or 2, x is 1 to 150, y is 0 to 15 and z is 0 to 4;

iv) 0 to 90 mol % of at least one component of the formula 6a, 6b, or 6c:

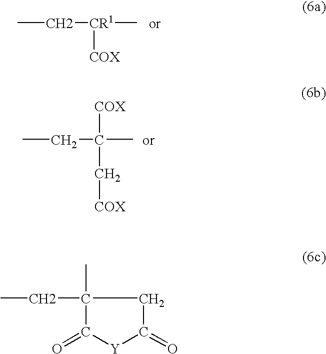

wherein M is a hydrogen atom, a mono- or divalent metal cation, an ammonium ion or an organic amine residue, a is 1, or when M is a divalent metal cation a is ½;

wherein X is —OMₐ,

—O—(CₘH₂ₘO)ₙ—R¹ in which R¹ is a hydrogen atom, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulphonic substituted aryl radical containing 6 to 14 carbon atoms, m is 2 to 4, and n is 0 to 100,

—NH—(CₘH₂ₘO)ₙ—R¹,

—NHR₂, —N(R²)² or mixtures thereof in which R²═R₁ or —CO—NH₂; and

wherein Y is an oxygen atom or —NR²;

k) a copolymer of dicarboxylic acid derivatives and oxyalkylene glycol-alkenyl ethers, comprising:

i) 1 to 90 mol. % of at least one member selected from the group consisting of structural units of Formula 7a and Formula 7b:

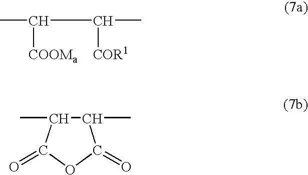

wherein M is H, a monovalent metal cation, a divalent metal cation, an ammonium ion or an organic amine;

a is ½ when M is a divalent metal cation or 1 when M is a monovalent metal cation;

wherein R¹ is —OMₐ, or

—O—(CₘH₂ₘO)ₙ—R² wherein R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of [—COOMₐ, —(SO₃)Mₐ, and —(PO₃)Mₐ₂];

m is 2 to 4;

n is 1 to 200;

ii) 0.5 to 80 mol. % of the structural units of Formula 8:

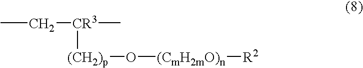

wherein R³ is H or a C₁₋₅ aliphatic hydrocarbon;

p is 0 to 3;

R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of [—COOMₐ, —(SO₃)Mₐ, and —(PO₃) Mₐ₂];

m is 2 to 4;

n is 1 to 200;

iii) 0.5 to 80 mol. % structural units selected from the group consisting of Formula 9a and Formula 9b:

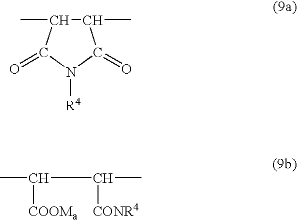

wherein R⁴ is H, C₁₋₂₀ aliphatic hydrocarbon that is optionally substituted with at least one hydroxyl group, —(CₘH₂ₘO)ₙ—R², —CO—NH—R², C₅₋₈ cycloaliphatic hydrocarbon, or a C₆₋₁₄ aryl that is optionally substituted with at least one member selected from the group consisting of [—COOMₐ, —(SO₃)Mₐ, and —(PO₃)Mₐ₂];

M is H, a monovalent metal cation, a divalent metal cation, an ammonium ion or an organic amine;

a is ½ when M is a divalent metal cation or 1 when M is a monovalent metal cation;

R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of [—COOMₐ, —(SO₃)Mₐ, and —(PO3)Mₐ₂];

m is 2 to 4;

n is 1 to 200;

iv) 1 to 90 mol. % of structural units of Formula 10

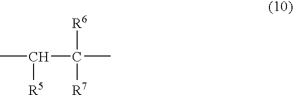

wherein R⁵ is methyl, or methylene group, wherein R⁵ forms one or more 5 to 8 membered rings with R⁷;

R⁶ is H, methyl, or ethyl;

R⁷ is H, a C₁₋₂₀ aliphatic hydrocarbon, a C₆₋₁₄ aryl that is optionally substituted with at least one member selected from the group consisting of [—COOMₐ, —(SO₃)Mₐ, and —(PO₃)Mₐ₂], a C₅₋₈ cycloaliphatic hydrocarbon, —OCOR⁴, —OR⁴, or —COOR⁴, wherein R⁴ is H, a C₁₋₂₀ aliphatic hydrocarbon that is optionally substituted with at least one —OH, —(CₘH₂ₘO)ₙ—R², —CO—NH—R², C₅₋₈ cycloaliphatic hydrocarbon, or a C₆₋₁₄ aryl residue that is optionally substituted with a member selected from the group consisting of [—COOMₐ, —(SO₃)Mₐ, —(PO₃)Mₐ₂].

In formula (e) the word “derived” does not refer to derivatives in general, but rather to any polycarboxylic acid/salt side chain derivatives of oligoalkyleneglycols, polyalcohols and polyalkylene glycols that are compatible with dispersant properties and do not destroy the graft polymer.

The preferred substituents in the optionally substituted aryl radical of formula (j), containing 6 to 14 carbon atoms, are hydroxyl, carboxyl, C₁₋₁₄ alkyl, or sulfonate groups.

The preferred substituents in the substituted benzene are hydroxyl, carboxyl, C₁₋₁₄ alkyl, or sulfonate groups.

The inorganic early set and strength accelerator used in the admixture of the present invention can include, but is not limited to, a nitrate salt of an alkali metal, alkaline earth metal, or aluminum; a nitrite salt of an alkali metal, alkaline earth metal, or aluminum, a thiocyanate salt of an alkali metal, alkaline earth metal or aluminum; an alkanolamine; a thiosulphate salt of an alkali metal, alkaline earth metal, or aluminum; a hydroxide of an alkali metal, alkaline earth metal, or aluminum; a carboxylic acid salt of an alkali metal, alkaline earth metal, or aluminum (in one embodiment calcium formate); a polyhydroxylalkylamine; a halide salt of an alkali metal or alkaline earth metal (in one embodiment bromide). In one embodiment the admixture composition comprises about 0.5% to about 30% inorganic early set and strength accelerator based on the total dry (active) weight of the admixture composition components. In another embodiment the admixture composition contains about 5% to about 10% inorganic early set and strength accelerator based on the total dry (active) weight of the admixture composition components. In a further embodiment a cementitious composition contains about 0.002% to about 0.3% inorganic early set and strength accelerator by weight of cementitious binder.

The salts of nitric acid have the general formula M(NO₃)ₐ where M is an alkali metal, or an alkaline earth metal or aluminum, and where a is 1 for alkali metal salts, 2 for alkaline earth salts, and 3 for aluminum salts. Preferred are nitric acid salts of Na, K, Mg, Ca and Al.

Nitrite salts have the general formula M(NO₂)ₐ where M is an alkali metal, or an alkaline earth metal or aluminum, and where a is 1 for alkali metal salts, 2 for alkaline earth salts, and 3 for aluminum salts. Preferred are nitric acid salts of Na, K, Mg, Ca and Al.

The salts of the thiocyanic acid have the general formula M(SCN)_{b}, where M is an alkali metal, or an alkaline earth metal or aluminum, and where b is 1 for alkali metal salts, 2 for alkaline earth salts and 3 for aluminum salts. These salts are variously known as sulfocyanates, sulfocyanides, rhodanates or rhodanide salts. Preferred are thiocyanic acid salts of Na, K, Mg, Ca and Al.

Alkanolamine is a generic term for a group of compounds in which trivalent nitrogen is attached directly to a carbon atom of an alkyl alcohol. A representative formula is N[H]_{c}[(CH₂)_{d}CH₂OH]ₑ; where c is 3-e, d is 1 to about 5 and e is 1 to about 3. Examples include, but are not limited to, are monoethanoalamine, diethanolamine and triethanolamine.

The thiosulfate salts have the general formula M_{f}(S₂O₃)_{g} where M is alkali metal or an alkaline earth metal or aluminum, and f is 1 or 2 and g is 1, 2 or 3, depending on the valencies of the M metal elements. Preferred are thiosulfate acid salts of Na, K, Mg, Ca and Al.

The carboxylic acid salts have the general formula RCOOM wherein R is H or C₁ to about C₁₀ alkyl, and M is alkali metal or an alkaline earth metal or aluminum. Preferred are carboxylic acid salts of Na, K, Mg, Ca and Al. A preferred carboxylic acid salt is calcium formate.

In one embodiment the polyhydroxylalkylamine has the general formula

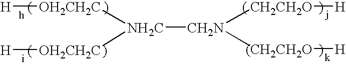

wherein h is 1 to 3, i is 1 to 3, j is 1 to 3, and k is 0 to 3. A preferred polyhydroxyalkylamine is tetrahydroxyethylethylenediamine.

The organic set accelerator is at least one of dimethylolurea, mono- and di(N-methylol) hydantoin, mono- and di(N-methylol) dimethylhydantoin, N-methylolacrylamide, tri(N-methylol) melamine, N-hydroxyethylpiperidine, glycolurils, glycolurils, methylolglycolurils, such as tri(N-methylol)glycoluril, tetra (N-methylol)glycoluril, and tetra (N-methylol)glycoluril N,N-bis(2-hydroxyethyl)piperazine, glutaraldehyde, pyruvaldehyde, furfural or water soluble urea-formaldehyde resins. In one embodiment the admixture composition comprises about 0.1% to about 8% organic set accelerator based on the total dry (active) weight of the admixture composition components. In another embodiment the admixture composition contains about 1.3% to about 6% organic set accelerator based on the total dry (active) weight of the admixture composition components. In a further embodiment a cementitious composition contains about 0.01% to about 0.16% organic set accelerator by weight of cementitious binder.

Buffering agent can be included in the admixture composition of the present invention to maintain the pH. In one embodiment the buffering agent is sodium acetate.

In one embodiment the soluble inorganic salt with freezing point depressant properties is at least one of ammonium nitrates, alkali metal nitrates, alkaline earth nitrates, ammonium nitrites, alkali metal nitrites, and alkaline earth nitrites. In certain embodiments calcium nitrate is used. In other embodiments the soluble inorganic salt may be partially replaced by urea. In another embodiment the admixture composition comprises about 75% to about 95% soluble inorganic salt based on the total dry (active) weight of the admixture composition components. In another embodiment the admixture composition contains about 80% to about 90% inorganic salt based on the total dry (active) weight of the admixture composition components. In a further embodiment a cementitious composition contains about 0.3% to about 4.0% soluble inorganic salt by weight of cementitious binder.

In theory, soluble inorganic salts provide freezing point depression by dissolving in the aqueous phase and interfering with molecular packing as the solution is cooled. The extent of this freezing point depression is governed by the characteristics of the aqueous phase and the amount of solute dissolved in the system. This phenomenon can be defined by the equation T=Kf*m, where T is the freezing point depression (C^{o}), Kf is the molal freezing point depression constant (C^{o}/mole) and m is the concentration of the solute (mole). Once the solubility limit of the solution is achieved, no further freezing point depression is achievable.

An example of a soluble inorganic salt that can be used in the present invention includes, but is not limited to calcium nitrite based corrosion inhibitor sold under the trademark RHEOCRETE® CNI by Master Builders Inc. of Cleveland, Ohio.

The hydraulic cement comprising the cementitious formulation is selected from the group consisting of portland cement, modified portland cement, or masonry cement, and mixtures thereof. By portland cement is meant all cementitious compositions which have a high content of tricalcium silicate and includes portland cement and cements that are chemically similar or analogous to portland cement, the specification for which is set forth in ASTM specification C 150-00.

Cementitious materials are materials that alone have hydraulic cementing properties, and set and harden in the presence of water. Included in cementitious materials are ground granulated blast-furnace slag, natural cement, hydraulic hydrated lime, and combinations of these and other materials.

Aggregate can be included in the cementitious formulation to provide for mortars which include fine aggregate, and concretes which also include coarse aggregate. The fine aggregate are materials that almost entirely pass through a Number 4 sieve (ASTM C 125 and ASTM C 33), such as silica sand. The coarse aggregate are materials that are predominantly retained on a Number 4 sieve (ASTM C 125 and ASTM C 33), such as silica, quartz, crushed round marble, glass spheres, granite, limestone, calcite, feldspar, alluvial sands, sands or any other durable aggregate, and mixtures thereof.

The cementitious composition described herein may contain other additives or ingredients and should not be limited to the stated formulations. Cement additives that can be added include, but are not limited to: air-entraining or air detraining agents, water reducers, retarders, corrosion inhibitors, pigments, wetting agents, water soluble polymers, strength enhancing agents, rheology modifying agents, water repellents, fibers, dampproofing admixtures, gas formers, permeability reducers, pumping aids, fungicidal admixtures, germicidal admixtures, insecticidal admixtures, finely divided mineral admixtures, alkali-reactivity reducer, bonding admixtures, shrinkage reducing admixtures, and any other admixture or additive that does not adversely affect the properties of the admixture of the present invention.

The term air entrainer includes any chemical that will entrain air in cementitious compositions. Air entrainers can also reduce the surface tension of a composition at low concentration. Air-entraining admixtures are used to purposely entrain microscopic air bubbles into concrete. Air-entrainment dramatically improves the durability of concrete exposed to moisture during cycles of freezing and thawing. In addition, entrained air greatly improves a concrete's resistance to surface scaling caused by chemical deicers. Air entrainment also increases the workability of fresh concrete while eliminating or reducing segregation and bleeding. Materials used to achieve these desired effects can be selected from wood resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, an inorganic air entrainer, synthetic detergents, and their corresponding salts, and mixtures thereof. Air entrainers are added in an amount to yield a desired level of air in a cementitious composition. Generally, the amount of air entrainers (about 5% to about 15% solids content) in a cementitious composition ranges from about 0.07 mL to about 3.9 mL per kilogram of dry cement. In one embodiment the dosage is about 0.33 mL to about 0.98 mL per kilogram of dry cement. Weight percentages of the primary active ingredient of the air entrainers, wherein the primary active ingredient in the air entrainer provides the desired effect i.e., entrapment of air in the cementitious composition, are about 0.001% to about 0.05%; based on the weight of dry cementitious material. But this can vary widely due to variations in materials, mix proportion, temperature, and mixing action. The air entrainer useful in the present admixture composition can be any known air entrainer for cement, including natural resin, synthetic resin, and mixtures thereof. Examples of air entrainers that can be utilized in the present invention include, but are not limited to those sold under the trademarks MB AE 90, MB VR and MICRO AIR®, all available from Master Builders Inc. of Cleveland, Ohio.

Air detrainers are used to decrease the air content in the cementitious composition. Examples of air detrainers that can be utilized in the present invention include, but are not limited to tributyl phosphate, dibutyl phthalate, octyl alcohol, water-insoluble esters of carbonic and boric acid, acetylenic diols, ethylene oxide-propylene oxide block copolymers and silicones.

Retarding admixtures, or also known as delayed-setting or hydration control admixtures, are used to retard, delay, or slow the rate of setting of concrete. They can be added to the concrete mix upon initial batching or sometime after the hydration process has begun. Retarders are used to offset the accelerating effect of hot weather on the setting of concrete, or delay the initial set of concrete or grout when difficult conditions of placement occur, or problems of delivery to the job site, or to allow time for special finishing processes or to aid in the reclamation of concrete that was delivered to the jobsite, but was unused and returned to the batch plant. Most retarders also act as water reducers and can also be used to entrain some air into concrete. Lignosulfonates, hydroxylated carboxylic acids, lignin, borax, gluconic, tartaric and other organic acids and their corresponding salts, phosphonates, certain carbohydrates and mixtures thereof can be used as retarding admixtures.

Corrosion inhibitors in concrete serve to protect embedded reinforcing steel from corrosion. The high alkaline nature of the concrete causes a passive and noncorroding protective oxide film to form on the steel. However, carbonation or the presence of chloride ions from deicers or seawater together with oxygen, can destroy or penetrate the film and result in corrosion. Corrosion-inhibiting admixtures chemically slow this corrosion reaction. The materials most commonly used to inhibit corrosion are calcium nitrite, sodium nitrite, sodium benzoate, certain phosphates or fluorosilicates, fluoroaluminates, amines, organic based water repelling agents, and related chemicals.

Dampproofing admixtures reduce the permeability of concrete that has low cement contents, high water-cement ratios, or a deficiency of fines in the aggregate portion. These admixtures retard moisture penetration into dry concrete and include certain soaps, stearates, and petroleum products.

Permeability reducers, are used to reduce the rate at which water under pressure is transmitted through concrete. Silica fume, fly ash, ground slag, metakaolin, natural pozzolans, water reducers, and latex can be employed to decrease the permeability of the concrete.

Pumping aids are added to concrete mixes to improve pumpability. These admixtures thicken the fluid concrete, i.e., increase its viscosity, to reduce dewatering of the paste while it is under pressure from the pump. Among the materials used as pumping aids in concrete are organic and synthetic polymers, hydroxyethylcellulose (HEC) or HEC blended with dispersants, organic flocculents, organic emulsions of paraffin, coal tar, asphalt, acrylics, bentonite and pyrogenic silicas, natural pozzolans, fly ash and hydrated lime.

Bacteria and fungal growth on or in hardened concrete may be partially controlled through the use of fungicidal, germicidal, and insecticidal admixtures. The most effective materials for these purposes are polyhalogenated phenols, dialdrin emulsions, and copper compounds.

Finely divided mineral admixtures are materials in powder or pulverized form added to concrete before or during the mixing process to improve or change some of the plastic or hardened properties of portland cement concrete. Portland cement, as used in the trade, means a hydraulic cement produced by pulverizing clinker, comprising hydraulic calcium silicates, calcium aluminates, and calcium aluminoferrites, and usually containing one or more of the forms of calcium sulfate as an interground addition. Portland cements are classified in ASTM C 150 as Type I II, III, IV, or V. The finely divided mineral admixtures can be classified according to their chemical or physical properties as: cementitious materials; pozzolans; pozzolanic and cementitious materials; and nominally inert materials.

A pozzolan is a siliceous or aluminosiliceous material that possesses little or no cementitious value but will, in the presence of water and in finely divided form, chemically react with the calcium hydroxide produced during the hydration of portland cement to form materials with cementitious properties. Diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Natural pozzolan is a term of art used to define the pozzolans that occur in nature, such as volcanic tuffs, pumices, trasses, diatomaceous earths, opaline, cherts, and some shales. Nominally inert materials can also include finely divided raw quartz, dolomites, limestones, marble, granite, and others. Fly ash is defined in ASTM C618.

Alkali-reactivity reducers can reduce the alkali-aggregate reaction and limit the disruptive expansion forces that this reaction can produce in hardened concrete. Pozzolans (fly ash, silica fume), blast-furnace slag, salts of lithium and barium are especially effective.

Bonding admixtures are usually added to portland cement mixtures to increase the bond strength between old and new concrete and include organic materials such as rubber, polyvinyl chloride, polyvinyl acetate, acrylics, styrene butadiene copolymers, and other powdered polymers.

Fresh concrete can sometimes be harsh because of faulty mixture proportions or certain aggregate characteristics such as particle shape and improper grading. Under these conditions, entrained air, which acts like a lubricant, can be used as a workability improving agent. Other workability agents include certain water reducing admixtures, some viscosity modifying admixtures and certain finely divided admixtures.

In the construction field, many methods of protecting concrete from tensile stresses and subsequent cracking have been developed through the years. One modern method involves distributing fibers throughout a fresh concrete mixture. Upon hardening, this concrete is referred to as fiber-reinforced concrete. Fibers can be made of zirconium materials, carbon, steel, fiberglass, or synthetic materials, e.g., polypropylene, nylon, polyethylene, polyester, rayon, high-strength aramid, or mixtures thereof.

The shrinkage reducing agent which can be used in the present invention can include but is not limited to RO(AO)₁₋₁₀H, wherein R is a C₁₋₅ alkyl or C₅₋₆ cycloalkyl radical and A is a C₂₋₃ alkylene radical, alkali metal sulfate, alkaline earth metal sulfates, alkaline earth oxides, preferably sodium sulfate and calcium oxide. TETRAGUARD® shrinkage reducing agent is preferred and is available from Master Builders Inc. of Cleveland, Ohio.

Natural and synthetic admixtures are used to color concrete for aesthetic and safety reasons. These coloring admixtures are usually composed of pigments and include carbon black, iron oxide, phthalocyanine, umber, chromium oxide, titanium oxide and cobalt blue.

In certain embodiments the present admixture can be used as a cold weather concrete set accelerator and strength enhancer. Low or freezing temperatures (e.g., 5° to −10° C.) present special problems in mixing, placing and curing of concrete. Concrete may freeze while saturated and as a result be of low strength, or there may be a slow development of strength. The present admixture depresses the mix water freezing point, so that the concrete mixture is less likely to freeze during the first few critical hours of curing at temperatures below 0° C. Additionally, the accelerated setting time provided by the admixture results in increased strength development even in cold weather placement conditions.

Examples of inventive cold weather cementitious admixture compositions were tested for the effect of their addition on the workability of cement paste and also their effect on the properties of concrete.

In Table 1 varying compositions of a cold weather admixture were tested to determine the level of polycarboxylate required in the composition that would provide an equivalent level of workability as compared to a cold weather admixture composition containing sulfonated naphthalene condensate sodium salt (NaBNS). The dispersant was the only component that was altered in the composition, and all compositions also contained equivalent levels of a soluble inorganic salt, an inorganic set and strength accelerator, an organic set accelerator, and a buffering agent. To determine the level of polycarboxylate dispersant in the new cold weather admixture composition that would match the workability provided by the cold weather admixture composition containing sulfonated naphthalene condensate sodium salt as the dispersant, cement pastes comprising the admixture compositions were tested for mass flow rate and spread (described below).

The paste mass flow rate is best determined with pastes that have a mass flow rate between about 75 and 100 grams/second. The dispersant dose and/or water to cement ratio should be adjusted to achieve a paste fluidity within this range.

In this study 200 g of water, including the weight of water contained in the admixture composition, is added to a plastic container. The admixture composition is weighed and added to the container containing the mix water and mixed well. 500 g of portland cement is weighed and placed in a plastic container. The cement and test admixture composition is combined and mixed by hand to wet the cement powder. The hand blended slurry is transferred into the mechanical mixing container, leaving as little paste as possible adhering to the plastic container. The cement paste slurry is mixed at 700 RPM for 2 minutes.

A paste mass flow test is conducted by taring out the weight of the paste collection container on a balance, filling a glass funnel with the paste after covering the outlet with a finger and simultaneously start a timer and begin collecting paste into the collection container from the funnel. The paste collection should stop and simultaneously stop the timer before the paste level reaches the upper portion of the funnel stem. The time and weight of paste collected is recorded. The test is immediately repeated and the second set of values recorded. The mass flow rate is calculated as the average of the two measurements.

To conduct a paste spread diameter test, nearly fill a right cylinder container with paste. Briefly hand mix the paste before filling the container to ensure no cement settlement has occurred. An acrylic plate is placed on top of the container and centered over the open end of the container; the assembly is then inverted while holding the container against the plate and placing the assembly on a level bench top. The container is lifted from the plate and the paste allowed to flow from the container. The paste should not be shaken from the container. The major and minor diameters should be measured to the nearest about 1 millimeter or two, measurement taken at 90 degrees to each other if nearly circular. Both measurements should be recorded. The paste spread is calculated as the average of the two measurements and reported in mm.

The cement paste mixture samples in Table 1 were prepared as described above and comprised 19.6 mL of the cold weather admixture composition (39.2 mL/kg of cement).

TABLE 1

| | Disp Conc. | Mass Flow | Spread |
|---|---|---|---|
| Formulation | (%) | Rate (g/s) | (mm) |
| NaBNS | 7.37 | 91 | 111 |
| PC-1 | 2.45 | 142 | 216 |
| PC-2 | 2 | 118 | 209 |
| PC-3 | 1.6 | 99 | 188 |
| PC-4 | 1.1 | 94 | 166 |
| PC-5 | 0.8 | 71 | 130 |

PC = Polycarboxylate Dispersant
BNS = Sulfonated Naphthalene Condensate Sodium Salt
Disp Conc. = Dispersant in admixture composition

Table 1 demonstrates that a much reduced level of polycarboxylate dispersant in the admixture formulation provided the same dispersing effect as that of a much higher level of sulfonated naphthalene condensate sodium salt dispersant in cement paste. The polycarboxylate dispersant at a concentration of 1.1% had a mass flow rate nearly identical to that of the sulfonated naphthalene condensate sodium salt dispersant which had a much higher concentration at 7.37%.

Based on the prior art it would have been expected to see an increase in dispersant performance of 200% to 300% when NaBNS dispersant is replaced with an equivalent solids amount of polycarboxylate dispersant. However, Table 1 demonstrates the unexpected results of the present invention in that when the NaBNS dispersant was replaced with an equivalent solids amount of polycarboxylate dispersant the dispersant performance increased not merely by 200% to 300%, but rather by 700%.

Concrete batches were prepared in the laboratory to demonstrate the effectiveness of the admixture composition of the present invention to allow concrete to set and gain strength under cold weather conditions. Concrete was prepared in the standard manner using ingredients that were stored at 10° C. The water content of the concrete batches was adjusted such that the slump of the concrete was in the range of 90 to 125 mm. Specimens that were cast for testing the initial setting time of the concrete and the compressive strength of the concrete were stored in three curing environments: −1° C., 10° C., and 21° C.

Six concrete batches were prepared, including a reference batch that did not contain the cold weather admixture composition. The other batches contained different dosages (6.5, 13.0, 39.1 or 58.7 mL/kg cement) of cold weather admixture composition PC-4 (from Table 1) as well as one dosage (58.7 mL/kg cement) of a cold weather admixture composition that was identical to PC-4 except that it contained 7.37% NaBNS as the high-range water reducing dispersant. The ingredients of each of the concrete batches and the testing results for each batch are listed in Table 2.

TABLE 2

| | Batch | | | | | |
|---|---|---|---|---|---|---|
| | 1 | 2 | 3 | 4 | 5 | 6 |
| Portland cement Type I/II, kg/m³ | 356 | 354 | 355 | 355 | 357 | 359 |
| Sand, kg/m³ | 768 | 765 | 766 | 765 | 769 | 774 |
| Stone, kg/m³ | 1139 | 1134 | 1136 | 1134 | 1141 | 1147 |
| Water, kg/m³ | 160 | 154 | 161 | 161 | 155 | 147 |
| Admixture Formulation | None | NaBNS | PC-4 | PC-4 | PC-4 | PC-4 |
| w/c | 0.450 | 0.436 | 0.455 | 0.453 | 0.436 | 0.410 |
| Water Reduction % | | 3.7 | −0.7 | −0.4 | 3.0 | 8.1 |
| Admixture Amount (mL/kg cement) | None | 58.7 | 6.5 | 13.0 | 39.2 | 58.7 |
| Slump (mm) | 90 | 125 | 95 | 120 | 110 | 115 |
| % Air | 1.7 | 2.7 | 1.9 | 2.0 | 2.1 | 2.4 |
| Concrete temp. (° C.) | 12 | 11 | 11 | 12 | 12 | 12 |
| Initial setting time, hrs., 21° C. cure | 4.3 | 2.8 | 3.0 | 3.3 | 2.4 | 1.6 |
| Initial setting time, hrs., 10° C. cure | 4.9 | 3.1 | 4.0 | 4.0 | 2.6 | 1.8 |
| Initial setting time, hrs., −1° C. cure | 10.8 | 4.5 | 8.4 | 8.3 | 3.9 | 2.4 |
| Compressive Strength, MPa | | | | | | |
| 1 Day, Cured at 21° C. | 15.1 | 18.0 | 15.7 | 14.3 | 18.3 | 22.9 |
| 1 Day, Cured at 10° C. | 6.8 | 8.6 | 8.1 | 8.3 | 7.6 | 11.0 |
| 7 Day, Cured at 21° C. | 33.0 | 36.7 | 33.4 | 34.3 | 36.7 | 42.1 |
| 7 Day, Cured at 10° C. | 29.9 | 35.4 | 29.0 | 29.5 | 33.7 | 42.1 |
| 7 Day, Cured at −1° C. (in molds) | 18.0 | 26.4 | 21.0 | 20.2 | 24.1 | 29.9 |
| 28 Day, Cured at 21° C. | 46.9 | 45.1 | 46.8 | 44.8 | 47.5 | 53.4 |
| 28 Day, Cured at 10° C. | 45.2 | 45.5 | 43.5 | 43.4 | 45.2 | 53.7 |
| 28 Day, Cured at −1° C. (in molds) | 31.8 | 44.7 | 38.6 | 39.2 | 42.3 | 49.7 |

PC = Polycarboxylate Dispersant
NaBNS = Sulfonated Naphthalene Condensate Sodium Salt

Table 2 shows that the water content of the concrete batches decreased as the dosage of the cold weather admixture composition increased, which demonstrates the effectiveness of the polycarboxylate dispersant in the admixture composition. The results of the initial setting time testing with −1° C. curing shows that the addition of the cold weather admixture composition accelerated the setting of the concrete, and that higher dosages of the cold weather admixture composition further accelerated the setting time of the concrete. At an equivalent dosage, the admixture composition containing polycarboxylate dispersant had a setting time two hours less than the admixture composition containing NaBNS, when the concrete was cured at −1° C. The results from the compressive strength testing with −1° C. curing shows that the addition of the cold weather admixture composition improved the compressive strength of the concrete after seven or twenty-eight days of curing, and that higher dosages of the cold weather admixture composition further improved the compressive strength of the concrete.

Concrete batches were prepared in the laboratory to demonstrate the effectiveness of an admixture composition of the present invention to allow concrete to set and gain strength under cold weather conditions. Concrete was prepared in the standard manner using ingredients that were stored at 10° C. The water content of the concrete batches was adjusted such that the slump of the concrete was in the range of 120 to 150 mm. Specimens that were cast for testing the initial setting time of the concrete ages and the compressive strength of the concrete at early age were stored in a curing environment of 21° C. and −7° C.

Four batches of air entrained concrete were prepared, including a reference batch that did not contain a cold weather admixture composition. The other batches contained one of two different dosages (39.1 or 58.7 mL/kg cement) of cold weather admixture composition PC-4 (from Table 1) as well as one dosage (58.7 mL/kg cement) of a cold weather admixture composition that was identical to PC-4 except that it contained 7.37% NaBNS as the high-range water reducing dispersant. The ingredients of each of the concrete batches and the testing results for each batch are listed in Table 3.

TABLE 3

| | Batch | | | |
|---|---|---|---|---|
| | 1 | 2 | 3 | 4 |
| Portland cement | 353 | 353 | 356 | 355 |
| Type I/II, kg/m³ | | | | |
| Sand, kg/m³ | 732 | 732 | 739 | 738 |
| Stone, kg/m³ | 1045 | 1045 | 1055 | 1054 |
| Water, kg/m³ | 160 | 157 | 147 | 156 |
| Admixture Formulation | none | PC-4 | PC-4 | NaBNS |
| w/c | 0.454 | 0.445 | 0.413 | 0.439 |
| Water reduction % | | 1.9 | 8.1 | 2.6 |
| Cold weather admixture | none | 39.1 | 58.7 | 58.7 |
| amount (mL/kg cement) | | | | |
| Air entraining admixture | 0.6 | 0.4 | 0.2 | 1.3 |
| amount (mL/kg cement) | | | | |
| Slump (mm) | 125 | 145 | 150 | 120 |
| % Air | 7.2 | 7.5 | 7.8 | 7.0 |
| Concrete temperature | 13 | 13 | 13 | 13 |
| (° C.) | | | | |
| Initial setting time, hrs., | 3.8 | 2.0 | 1.9 | 2.4 |
| 21° C. cure | | | | |
| Initial setting time, hrs., | | 3.8 | 3.3 | 4.7 |
| −7° C. cure | | | | |
| Compressive | | | | |
| Strength, Mpa | | | | |
| 3 Days, 21° C. cure | 20.7 | 26.7 | 34.8 | 31.3 |
| 3 Days, −7° C. cure | | 6.7 | 11.4 | 8.1 |

PC = Polycarboxylate Dispersant
NaBNS = Sulfonated naphthalene condensate sodium salt

Table 3 shows that the water content of the concrete batches decreased as the dosage of the cold weather admixture composition of the present invention increased, which demonstrates the effectiveness of the polycarboxylate dispersant in the admixture composition. The results of the initial setting time testing with −7° C. curing demonstrates that the addition of the cold weather admixture composition of the present invention accelerates the setting of the concrete, and that a higher dosage further accelerates the setting time of the concrete. At an equivalent dosage, the cold weather admixture composition containing NaBNS was less effective at accelerating the setting time of the concrete, when the concrete was cured at −7° C. The results from the compressive strength testing show that the addition of the cold weather admixture composition of the present invention develops concrete compressive strength after three days of curing at −7° C., and that a higher dosage further improves the compressive strength of the concrete. Additionally, at an equivalent dosage, the cold weather admixture composition containing NaBNS was less effective at accelerating the compressive strength development of the concrete, when the concrete was cured at −7° C.

It should be appreciated that the present invention is not limited to the specific embodiments described above, but includes variations, modifications and equivalent embodiments defined by the following claims. Further all embodiments disclosed are not necessarily in the alternative, various embodiments of the invention may be combined to provide the desired characteristics.

What is claimed is:

1. A cold weather admixture composition for cementitious compositions comprising the components of:
a) soluble inorganic salt having freezing point depressing properties;
b) inorganic early set and strength accelerator;
c) polycarboxylate high range water reducing dispersant; and
d) organic set accelerator.

2. The admixture composition of claim 1, wherein the amount of polycarboxylate high range water reducing dispersant is from about 0.4% to about 15%, the inorganic early set and strength accelerator is from about 0.5% to about 30%, the soluble inorganic salt is about 75% to about 95%, and the organic set accelerator is from about 0.1% to about 8% based on the total dry (active) weight of the admixture composition components.

3. The admixture composition of claim 1, wherein the amount of soluble inorganic salt is about 80% to about 90%, the polycarboxylate high range water reducing dispersant is about 1% to about 6%, the inorganic early set and strength accelerator is from about 5% to about 10%, and the organic set accelerator is from about 1.3% to about 6% based on the total dry (active) weight of the admixture composition.

4. The admixture composition of claim 1, wherein the admixture composition is chloride-free.

5. The admixture composition of claim 1, wherein the soluble inorganic salt having freezing point depressing properties is at least one of ammonium nitrates, alkali metal nitrates, alkaline earth nitrates, ammonium nitrites, alkali metal nitrites, and alkaline earth nitrites.

6. The admixture composition of claim 5, wherein the soluble inorganic salt component comprises at least one of calcium nitrate and urea.

7. The admixture composition of claim 1, wherein the inorganic early set and strength accelerator comprises at least one of:
a) a thiocyanate salt of an alkali metal, alkaline earth metal, ammonium or aluminum;
b) an alkanolamine;
c) a thiosulphate salt of an alkali metal, an alkaline earth metal, ammonium or aluminum;
d) a hydroxide of an alkali metal, alkaline earth metal, or aluminum;
e) a carboxylic acid salt of an alkali metal, alkaline earth metal, or aluminum;
f) a polyhydroxylalkylamine; or
g) a halide salt of an alkali metal or alkaline earth metal.

8. The admixture composition of claim 1, wherein the organic set accelerator is at least one of methylolglycoluril, glycoluril, dimethylolurea, mono- and di(N-methylol) hydantoin, mono- and di(N-methylol) dimethylhydantoin, N-methylolacrylamide, tri(N-methylol) melamine, N-hydroxyethylpiperidine, N,N-bis(2-hydroxyethyl)piperazine, glutaraldehyde, pyruvaldehyde, furfural or water soluble urea-formaldehyde resins.

9. The admixture composition of claim 8, wherein the methylolglycoluril is at least one of tri(N-methylol)glycoluril, tetra (N-methylol)glycoluril or tetra (N-methylol)glycoluril.

10. The admixture composition of claim 1 further comprising at least one of set retarders, air detraining agents, air entraining agents, shrinkage reducing admixture, water reducer, foaming agents, dampproofing admixtures, pumping aids, fungicidal admixtures, insecticidal admixtures, germicidal admixtures, alkali activity reducers, bonding admixtures, corrosion inhibitors, and pigments.

11. The admixture composition of claim 1, wherein the admixture composition is in an aqueous solution.

12. A cementitious composition comprising hydraulic cement and a cold weather admixture composition, said admixture composition comprising:
a) soluble inorganic salt having freezing point depressing properties;
s) inorganic early set and strength accelerator;
c) polycarboxylate high range water reducing dispersant; and
d) organic set accelerator.

13. The cementitious composition of claim 12, wherein the amount of polycarboxylate high range water reducing dispersant is from about 0.01% to about 0.2%, the inorganic early set and strength accelerator is from about 0.002% to about 0.3%, the soluble inorganic salt is from about 0.3% to about 4.0%, and the organic set accelerator is from about 0.01% to about 0.16% by weight of cementitious binder.

14. The cementitious composition of claim 12, wherein the soluble inorganic salt component comprises at least one of calcium nitrate and urea.

15. The cementitious composition of claim 12, wherein the cementitious composition is chloride-free.

16. The cementitious composition of claim 12, wherein the soluble inorganic salt having freezing point depressing properties is at least one of ammonium nitrates, alkali metal nitrates, alkaline earth nitrates, ammonium nitrites, alkali metal nitrites, and alkaline earth nitrites.

17. The cementitious composition of claim 12, wherein the inorganic early set and strength accelerator comprises at least one of:
a) a thiocyanate salt of an alkali metal, alkaline earth metal, ammonium or aluminum;
b) an alkanolamine;
c) a thiosulphate salt of an alkali metal, an alkaline earth metal, ammonium or aluminum;
d) a hydroxide of an alkali metal, alkaline earth metal, or aluminum;
e) a carboxylic acid salt of an alkali metal, alkaline earth metal, or aluminum;
f) a polyhydroxylalkylamine; or
g) a halide salt of an alkali metal or alkaline earth metal.

18. The cementitious composition of claim 12, wherein the organic set accelerator is at least one of methylolglycoluril, glycoluril, dimethylolurea, mono- and di(N-methylol) hydantoin, mono- and di(N-methylol) dimethylhydantoin, N-methylolacrylamide, tri(N-methylol) melamine, N-hydroxyethylpiperidine, N,N-bis(2-hydroxyethyl)piperazine, glutaraldehyde, pyruvaldehyde, furfural or water soluble urea-formaldehyde resins.

19. The cementitious composition of claim 18, wherein the methylolglycoluril is at least one of tri(N-methylol)glycoluril, tetra (N-methylol)glycoluril or tetra (N-methylol)glycoluril.

20. The cementitious composition of claim 12, wherein the cement is selected from the group consisting of portland cement, modified portland cement, or masonry cement, and mixtures thereof.

21. The cementitious composition of claim 12, wherein an air entrainer is present in an amount of about 0.07 mL to about 3.9 mL per kg of cementitious solids.

22. The cementitious composition of claim 12 further comprising a cement admixture or additive that is selected from the group consisting of air detraining agent, air entraining agent, foaming agent, corrosion inhibitor, shrinkage reducing admixture, water reducer, retarder, fiber, pigment, pozzolan, clay, strength enhancing agents, rheology modifying agents, water repellents, wetting agents, water soluble polymers, dampproofing admixtures, gas formers, permeability reducers, pumping aids, fungicidal admixtures, germicidal admixtures, insecticidal admixtures, aggregates, alkali- reaction reducers, bonding admixtures, and mixtures thereof.

23. The cementitious composition of claim 22, wherein the aggregate is at least one of silica, quartz, crushed round marble, glass spheres, granite, limestone, calcite, feldspar, alluvial sands, and sand.

24. The cementitious composition of claim 22, wherein the pozzolan is at least one of natural pozzolan, metakaolin, fly ash, silica fume, calcined clay, and blast furnace slag.

25. The composition of claim 1 or 12 wherein the polycarboxylate high range water reducing dispersant is at least one of:
a) a dispersant of Formula (I): 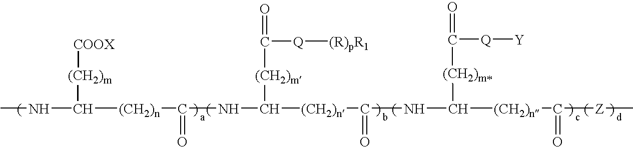
wherein in Formula (I)
X is at least one of hydrogen, an alkali earth metal ion, an alkaline earth metal ion, ammonium ion, or amine;
R is at least one of C₁ to C₆ alkyl(ene) ether or mixtures thereof or C₁ to C₆ alkyl(ene) imine or mixtures thereof;
Q is at least one of oxygen, NH, or sulfur;
p is a number from 1 to about 300 resulting in at least one of a linear side chain or branched side chain;
R₁ is at least one of hydrogen, C₁ to C₂₀ hydrocarbon, or functionalized hydrocarbon containing at least one of —OH, —COOH, an ester or amide derivative of —COOH, sulfonic acid, an ester or amide derivative of sulfonic acid, amine, or epoxy;
Y is at least one of hydrogen, an alkali earth metal ion, an alkaline earth metal ion, ammonium ion, amine, a hydrophobic hydrocarbon or polyalkylene oxide moiety that functions as a defoamer;
m, m′, m″, n, n′, and n″ are each independently 0 or an integer between 1 and about 20;
Z is a moiety containing at least one of i) at least one amine and one acid group, ii) two functional groups capable of incorporating into the backbone selected from the group consisting of dianhydrides, dialdehydes, and di-acid-chlorides, or iii) an imide residue; and
wherein a, b, c, and d reflect the mole fraction of each unit wherein the sum of a, b, c, and d equal one, wherein a, b, c, and d are each a value greater than or equal to zero and less than one, and at least two of a, b, c, and d are greater than zero;
b) a dispersant of Formula (II): 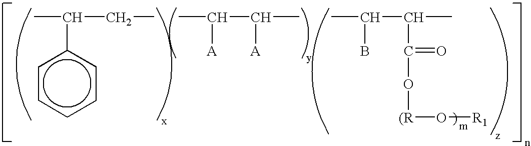
wherein in Formula (II):
A is COOM or optionally in the “y” structure an acid anhydride group (—CO—O—CO—) is formed in place of the A groups between the carbon atoms to which the A groups are bonded to form an anhydride;
B is COOM
M is hydrogen, a transition metal cation, the residue of a hydrophobic polyalkylene glycol or polysiloxane, an alkali metal ion, an alkaline earth metal ion, ferrous ion, aluminum ion, (alkanol)ammonium ion, or (alkyl)ammonium ion;
R is a C₂₋₆ alkylene radical;
R₁ is a C₁₋₂₀ alkyl, C₆₋₉ cycloalkyl, or phenyl group;
x, y, and z are a number from 0.01 to 100;
m is a number from 1 to 100; and
n is a number from 10 to 100;
c) a dispersant comprising at least one polymer or a salt thereof having the form of a copolymer of
i) a maleic anhydride half-ester with a compound of the formula RO(AO)ₘH, wherein R is a C₁-C₂₀ alkyl group, A is a C₂₋₄ alkylene group, and m is an integer from 2-16; and
ii) a monomer having the formula CH₂═CHCH₂—(OA)ₙOR, wherein n is an integer from 1-90 and R is a C₁₋₂₀ alkyl group;
d) a dispersant obtained by copolymerizing 5 to 98% by weight of an (alkoxy)polyalkylene glycol mono(meth)acrylic ester monomer (a) represented by the following general formula (1): 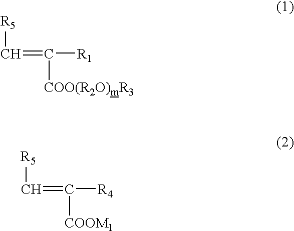
wherein R₁ stands for hydrogen atom or a methyl group, R₂O for one species or a mixture of two or more species of oxyalkylene group of 2 to 4 carbon atoms, providing two or more species of the mixture may be added either in the form of a block or in a random form, R₃ for a hydrogen atom or an alkyl group of 1 to 5 carbon atoms, and m is a value indicating the average addition mol number of oxyalkylene groups that is an integer in the range of 1 to 100, 95 to 2% by weight of a (meth)acrylic acid monomer (b) represented by the above general formula (2), wherein R₄ and R₅ are each independently a hydrogen atom or a methyl group, and M₁ for a hydrogen atom, a monovalent metal atom, a divalent metal atom, an ammonium group, or an organic amine group, and 0 to 50% by weight of other monomer (c) copolymerizable with these monomers, provided that the total amount of (a), (b), and (c) is 100% by weight;
e) a graft polymer that is a polycarboxylic acid or a salt thereof, having side chains derived from at least one species selected from the group consisting of oligoalkyleneglycols, polyalcohols, polyoxyalkylene amines, and polyalkylene glycols;
f) a reaction product of component A, optionally component B, and component C;
wherein each component A is independently a nonpolymeric, multi-functional moiety or combination of mono or multifunctional moieties that adsorbs onto a cementitious particle, and contains at least one residue derived from a first component selected from the group consisting of phosphates, phosphonates, phosphinates, hypophosphites, sulfates, sulfonates, sulfinates, alkyl trialkoxy silanes, alkyl triacyloxy silanes, alkyl triaryloxy silanes, borates, boronates, boroxines, phosphoramides, amines, amides, quaternary ammonium groups, carboxylic acids, carboxylic acid esters, alcohols, carbohydrates, phosphate esters of sugars, borate esters of sugars, sulfate esters of sugars, salts of any of the preceding moieties, and mixtures thereof;
wherein component B is an optional moiety, where if present, each component B is independently a nonpolymeric moiety that is disposed between the component A moiety and the component C moiety, and is derived from a second component selected from the group consisting of linear saturated hydrocarbons, linear unsaturated hydrocarbons, saturated branched hydrocarbons, unsaturated branched hydrocarbons, alicyclic hydrocarbons, heterocyclic hydrocarbons, aryl, phosphoester, nitrogen containing compounds, and mixtures thereof; and
wherein component C is at least one moiety that is a linear or branched water soluble, nonionic polymer substantially non-adsorbing to cement particles, and is selected from the group consisting of poly(oxyalkylene glycol), poly(oxyalkylene amine), poly(oxyalkylene diamine), monoalkoxy poly(oxyalkylene amine), monoaryloxy poly(oxyalkylene amine), monoalkoxy poly(oxyalkylene glycol), monoaryloxy poly(oxyalkylene glycol), poly(vinyl pyrrolidones), poly(methyl vinyl ethers), poly(ethylene imines), poly(acrylamides), polyoxazoles, and mixtures thereof; and
g) a dispersant of Formula (III): 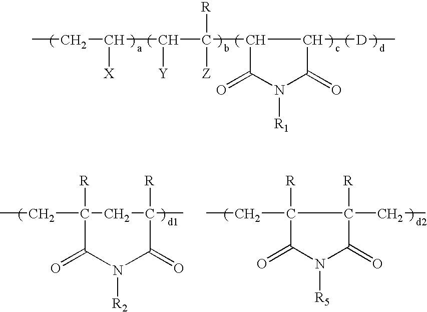
wherein in Formula (III):
D=a component selected from the group consisting of the structure d1, the structure d2, and mixtures thereof;
X=H, CH₃, C₂ to C₆ Alkyl, Phenyl, p-Methyl Phenyl, or Sulfonated Phenyl;
Y=H or —COOM;
R=H or CH₃;
Z=H, —SO₃M, —PO₃M, —COOM, —O(CH₂)ₙOR₃ where n=2 to 6,
—COOR₃, or —(CH₂)ₙOR₃ where n=0 to 6,
—CONHR₃, —CONHC(CH₃)₂ CH₂SO₃M, —COO(CHR₄)ₙOH where n=2 to 6, or —O(CH₂)ₙOR₄ wherein n=2 to 6;
R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;
R₄=H, Methyl, C₂ to about C₆ Alkyl, or about C₆ to about C₁₀ aryl;
M=H, Alkali Metal, Alkaline Earth Metal, Ammonium, Amine, triethanol amine, Methyl, or C₂ to about C₆ Alkyl;
a=0 to about 0.8;
b=about 0.2 to about 1.0;
c=0 to about 0.5;
d=0 to about 0.5; and
wherein a, b, c, and d represent the mole fraction of each unit and the sum of a, b, c, and d is 1.0;
h) a dispersant of Formula (IV): 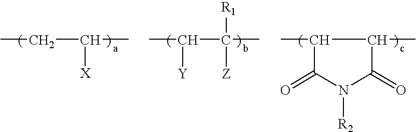
wherein in Formula (IV):
the “b” structure is one of a carboxylic acid monomer, an ethylenically unsaturated monomer, or maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage;
X=H, CH₃, C₂ to C₆ Alkyl, Phenyl, p-Methyl Phenyl, p-Ethyl Phenyl, Carboxylated Phenyl, or Sulfonated Phenyl;
Y=H, —COOM, —COOH, or W;
W=a hydrophobic defoamer represented by the formula R₅O—(CH₂CH₂O)ₛ—(CH₂C(CH₃)HO)ₜ—(CH₂CH₂O)ᵤ where s, t, and u are integers from 0 to 200 with the proviso that t>(s+u) and wherein the total amount of hydrophobic defoamer is present in an amount less than about 10% by weight of the polycarboxylate dispersant;
Z=H, —COOM, —O(CH₂)ₙOR₃ where n=2 to 6, —COOR₃, —(CH₂)ₙOR₃ where n=0 to 6, or —CONHR₃;
R₁=H, or CH₃;
R₂, R₃, are each independently a random copolymer of oxyethylene units and oxypropylene units of the general formula —(CH(R₁)CH₂O)ₘR₄ where m=10 to 500 and wherein the amount of oxyethylene in the random copolymer is from about 60% to 100% and the amount of oxypropylene in the random copolymer is from 0% to about 40%;
R₄=H, Methyl, or C₂ to C₈ Alkyl;
R₅=C₁ to C₁₈ alkyl or C₆ to C₁₈ alkyl aryl;
M=Alkali Metal, Alkaline Earth Metal, Ammonia, Amine, monoethanol amine, diethanol amine, triethanol amine, morpholine, imidazole;
a=0.01-0.8;
b=0.2-0.99;
c=0-0.5; and
wherein a, b, c represent the mole fraction of each unit and the sum of a, b, and c, is 1;
i) a random copolymer corresponding to the following Formula (V) in free acid or salt form having the following monomer units and numbers of monomer units: 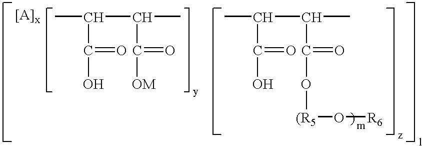
wherein A is selected from the moieties (i) or (ii)
(i) —CR₁R₂—CR₃R₄— 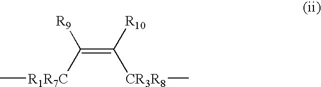
wherein R₁ and R₃ are selected from substituted benzene, C₁₋₈ alkyl, C₂₋₈ alkenyl, C₂₋₈ alkylcarbonyl, C₁₋₈ alkoxy, carboxyl, hydrogen, and a ring, R₂ and R₄ are selected from the group consisting of hydrogen and C₁₋₄ alkyl, wherein R₁ and R₃ can together with R₂ and/or R₄ when R₂ and/or R₄ are C₁₋₄ alkyl form the ring;
R₇, R₈, R₉, and R₁₀ are individually selected from the group consisting of hydrogen, C₁₋₆ alkyl, and a C₂₋₈ hydrocarbon chain, wherein R₁ and R₃ together with R₇ and/or R₈, R₉, and R₁₀ form the C₂₋₈ hydrocarbon chain joining the carbon atoms to which they are attached, the hydrocarbon chain optionally having at least one anionic group, wherein the at least one anionic group is optionally sulfonic;
M is selected from the group consisting of hydrogen, and the residue of a hydrophobic polyalkylene glycol or a polysiloxane, with the proviso that when A is (ii) and M is the residue of a hydrophobic polyalkylene glycol, M must be different from the group —(R₅O)ₘR₆;
R₅ is a C₂₋₈ alkylene radical;
R₆ is selected from the group consisting of C₁₋₂₀ alkyl, C₆₋₉ cycloalkyl and phenyl;
n, x, and z are numbers from 1 to 100;
y is 0 to 100;
m is 2 to 1000;
the ratio of x to (y+z) is from 1:10 to 10:1 and the ratio of y:z is from 5:1 to 1:100;
j) a copolymer of oxyalkyleneglycol-alkenyl ethers and unsaturated dicarboxylic acids, comprising:
i) 0 to 90 mol % of at least one component of the formula 3a or 3b: 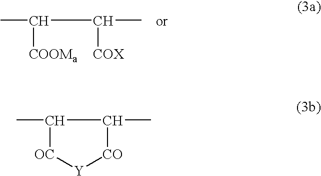
wherein M is a hydrogen atom, a mono- or divalent metal cation, an ammonium ion or an organic amine residue, a is 1, or when M is a divalent metal cation a is ½;
wherein X is —OMa,
—O—(CₘH₂ₘO)ₙ—R¹ in which R¹ is a hydrogen atom, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulphonic substituted aryl radical containing 6 to 14 carbon atoms, m is 2 to 4, and n is 0 to 100,
—NHR₂, —N(R²)₂ or mixtures thereof in which R²═R¹ or —CO—NH²; and
wherein Y is an oxygen atom or —NR²;
ii) 1 to 89 mol % of components of the general formula 4: 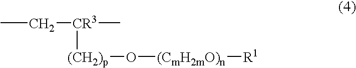
wherein R₃ is a hydrogen atom or an aliphatic hydrocarbon radical containing from 1 to 5 carbon atoms, p is 0 to 3, and R₁ is hydrogen, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulfonic substituted aryl radical containing 6 to 14 carbon atoms, m is 2 to 4, and n is 0 to 100, and
iii) 0.1 to 10 mol % of at least one component of the formula 5a or 5b: 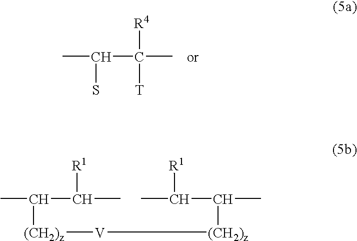
wherein S is a hydrogen atom or —COOMₐ or —COOR₅, T is —COOR₅, —W—R₇, —CO—[—NH—(CH2)3)—]ₛ—W—R₇, —CO—O—(CH₂)_{z}—W—R₇, a radical of the general formula: 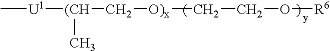
or —(CH₂)_{z}—V—(CH₂)_{z}—CH═CH—R₁, or when S is —COOR₅ or —COOMₐ, U₁ is —CO—NHM-, —O— or —CH₂O, U₂ is —NH—CO—, —O— or —OCH₂, V is —O—CO—C₆H₄—CO—O— or —W—, and W is 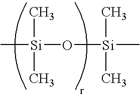
R4 is a hydrogen atom or a methyl radical, R5 is an aliphatic hydrocarbon radical containing 3 to 20 carbon atoms, a cycloaliphatic hydrocarbon radical containing 5 to 8 carbon atoms or an aryl radical containing 6 to 14 carbon atoms, R₆═R₁ or 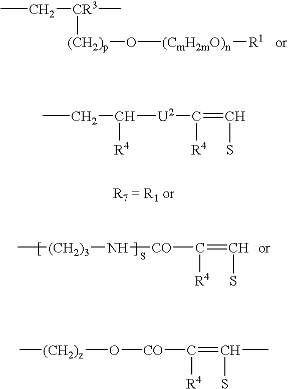
r is 2 to 100, s is 1 or 2, x is 1 to 150, y is 0 to 15 and z is 0 to 4;
iv) 0 to 90 mol % of at least one component of the formula 6a, 6b, or 6c: 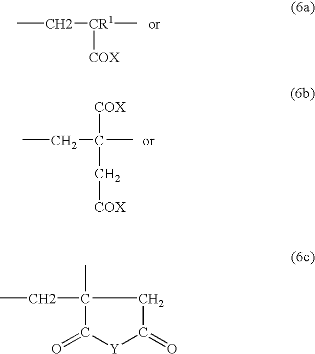
wherein M is a hydrogen atom, a mono- or divalent metal cation, an ammonium ion or an organic amine residue, a is 1, or when M is a divalent metal cation a is ½
wherein X is —OMₐ,
—O—(CₘH₂ₘO)ₙ—R¹ in which R¹ is a hydrogen atom, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulphonic substituted aryl radical containing 6 to 14 carbon atoms, m is 2 to 4, and n is 0 to 100,
—NH—(CₘH₂ₘO)ₙ—R¹,
—NHR₂, —N(R²)₂ or mixtures thereof in which R²═R¹ or —CO—NH₂; and
wherein Y is an oxygen atom or —NR²;
k) a copolymer of dicarboxylic acid derivatives and oxyalkylene glycol-alkenyl ethers, comprising:
i) 1 to 90 mol. % of at least one member selected from the group consisting of structural units of Formula 7a and Formula 7b: 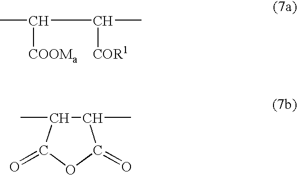
wherein M is H, a monovalent metal cation, a divalent metal cation, an ammonium ion or an organic amine;
a is ½ when M is a divalent metal cation or 1 when M is a monovalent metal cation;
wherein R¹ is —OMₐ, or
—O—(CₘH₂ₘO)ₙ—R² wherein R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of [—COOMₐ, —(SO₃)Mₐ, and —(PO₃)Mₐ₂];
m is 2 to 4;
n is 1 to 200;
ii) 0.5 to 80 mol. % of the structural units of Formula 8: 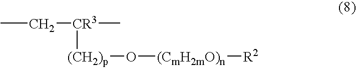
wherein R³ is H or a C₁₋₅ aliphatic hydrocarbon;
p is 0 to 3;
R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of [—COOMₐ, —(SO₃)Mₐ, and —(PO₃)Mₐ₂];
m is 2 to 4;
n is 1 to 200;
iii) 0.5 to 80 mol. % structural units selected from the group consisting of Formula 9a and Formula 9b: 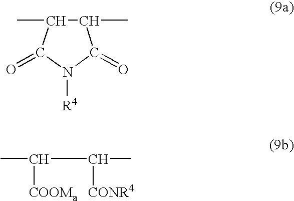
wherein R⁴ is H, C₁₋₂₀ aliphatic hydrocarbon that is optionally substituted with at least one hydroxyl group, —(CₘH₂ₘO)ₙ—R², —CO—NH—R², C₅₋₈ cycloaliphatic hydrocarbon, or a C₆₋₁₄ aryl that is optionally substituted with at least one member selected from the group consisting of [—COOMₐ, —(SO₃)Mₐ, and —(PO₃)Mₐ₂];
M is H, a monovalent metal cation, a divalent metal cation, an ammonium ion or an organic amine;
a is ½ when M is a divalent metal cation or 1 when M is a monovalent metal cation;
R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of [—COOMₐ, —(SO₃)Mₐ, and —(PO₃)Mₐ₂];
m is 2 to 4;
n is 1 to 200;
iv) 1 to 90 mol. % of structural units of Formula 10 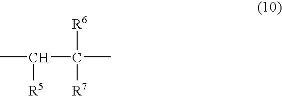
wherein R⁵ is methyl, or methylene group, wherein R⁵ forms one or more 5 to 8 membered rings with R⁷;
R⁶ is H, methyl, or ethyl;
R⁷ is H, a C₁₋₂₀ aliphatic hydrocarbon, a C₆₋₁₄ aryl that is optionally substituted with at least one member selected from the group consisting of [—COOMₐ, —(SO₃)Mₐ, and —(PO₃)Mₐ₂], a C₅₋₈ cycloaliphatic hydrocarbon, —OCOR⁴, —OR⁴, or —COOR⁴, wherein R⁴ is H, a C₁₋₂₀ aliphatic hydrocarbon that is optionally substituted with at least one —OH, −(CₘH₂ₘO)ₙ—R², —CO—NH—R², C₅₋₈ cycloaliphatic hydrocarbon, or a C₆₋₁₄ aryl residue that is optionally substituted with a member selected from the group consisting of [—COOMₐ, —(SO₃)Mₐ, —(PO₃)Mₐ₂].

26. A method of making a cementitious composition comprising forming a mixture of water, hydraulic cement and a cold weather admixture composition, said admixture composition comprising the components of:
a) a soluble inorganic salt having freezing point depressing properties;
b) an inorganic early set and strength accelerator;
c) a polycarboxylate high range water reducing dispersant; and
d) an organic set accelerator.

27. The method of claim 26, wherein the amount of high range water reducing dispersant is from about 0.01% to about 0.2%, the inorganic early set and strength accelerator is from about 0.002% to about 0.3%, the soluble inorganic salt is from about 0.3% to about 4.0%, and the organic set accelerator is from about 0.01% to about 0.16% by weight of cementitious binder.

28. The method of claim 26, wherein the soluble inorganic salt component comprises at least one of calcium nitrate and urea.

29. The method of claim 26, wherein the cementitious composition is chloride-free.

30. The method of claim 26, wherein the soluble inorganic salt having freezing point depressing properties is at least one of ammonium nitrates, alkali metal nitrates, alkaline earth nitrates, ammonium nitrites, alkali metal nitrites, and alkaline earth nitrites.

31. The method of claim 26, wherein the inorganic early set and strength accelerator comprises at least one of:
a) a thiocyanate of an alkali metal, alkaline earth metal, ammonium or aluminum;
b) an alkanolamine;
c) a thiosulphate of an alkali metal, alkaline earth metal, ammonium or aluminum;
d) a hydroxide of an alkali metal, alkaline earth metal, or aluminum;
e) a carboxylic acid salt of an alkali metal, alkaline earth metal, or aluminum;
f) a polyhydroxylalkylamine; or
g) a halide salt of an alkali metal or alkaline earth metal.

32. The method of claim 26, wherein the organic set accelerator is at least one of methylolglycoluril, glycoluril, dimethylolurea, mono- and di(N-methylol) hydantoin, mono- and di(N-methylol) dimethylhydantoin, N-methylolacrylamide, tri(N-methylol) melamine, N-hydroxyethylpiperidine, N,N-bis(2-hydroxyethyl)piperazine, glutaraldehyde, pyruvaldehyde, furfural or water soluble urea-formaldehyde resins.

33. The method of claim 32, wherein the methylolglycoluril is at least one of tri(N-methylol)glycoluril, tetra (N-methylol)glycoluril or tetra (N-methylol)glycoluril.

34. The method of claim 26, wherein the cement is selected from the group consisting of portland cement, modified portland cement, or masonry cement, and mixtures thereof.

35. The method of claim 26, wherein an air entrainer is present in an amount of about 0.07 mL to about 3.9 mL per kg of cementitious solids.

36. The method of claim 26, further comprising a cement admixture or additive that is selected from the group consisting of air detraining agent, air entraining agent, foaming agent, corrosion inhibitor, shrinkage reducing admixture, water reducer, retarders, fiber, pigment, pozzolan, clay, strength enhancing agents, rheology-modifying agents, water repellents, wetting agents, water soluble polymers, dampproofing admixtures, gas formers, permeability reducers, pumping aids, fungicidal admixtures, germicidal admixtures, insecticidal admixtures, alkali- reaction reducers, aggregate, bonding admixtures, and mixtures thereof.

37. The method composition of claim 36, wherein the aggregate is at least one of silica, quartz, crushed round marble, glass spheres, granite, limestone, calcite, feldspar, alluvial sands, and sand.

38. The method composition of claim 36, wherein the pozzolan is at least one of natural pozzolan, metakaolin, fly ash, silica fume, calcined clay, and blast furnace slag.

39. A cold weather admixture composition for cementitious compositions comprising:
a) soluble inorganic salt having freezing point depressing properties;
b) inorganic early set and strength accelerator; and
c) a polycarboxylate high range water reducing dispersant;
wherein the polycarboxylate high range water reducing dispersant has the general structure shown below: 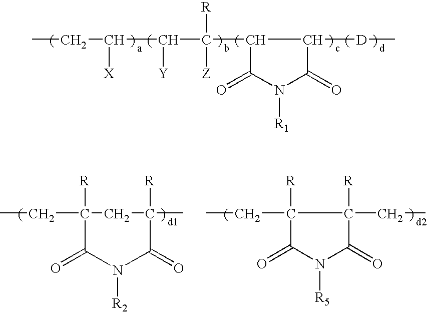
wherein in Formula (III):
D=a component selected from the group consisting of the structure d1, the structure d2, and mixtures thereof;
X=H, CH₃, C₂ to C₆ Alkyl, Phenyl, p-Methyl Phenyl, or Sulfonated Phenyl;
Y=H or —COOM;
R=H or CH₃;
Z=H, —SO₃M, —PO₃M, —COOM, —O(CH₂)ₙOR₃ where n=2 to 6, —COOR₃, or —(CH₂)ₙOR₃ where n=0 to 6, —CONHR₃, —CONHC(CH₃)₂ CH₂SO₃M, —COO(CHR₄)ₙOH where n=2 to 6, or —O(CH₂)ₙOR₄ wherein n=2 to 6;
R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;
R₄=H, Methyl, C₂ to about C₆ Alkyl, or about C₆ to about C₁₀ aryl;
M=H, Alkali Metal, Alkaline Earth Metal, Ammonium, Amine, triethanol amine, Methyl, or C₂ to about C₆ Alkyl;
a=0 to about 0.8;
b=about 0.2 to about 1.0;
c=0 to about 0.5;
d=0 to about 0.5; and
wherein a, b, c, and d represent the mole fraction of each unit and the sum of a, b, c, and d is 1.0; and
d) an organic set accelerator.

40. The admixture composition of claim 39, wherein the soluble inorganic salt having freezing point depressing properties is at least one of ammonium nitrates, alkali metal nitrates, alkaline earth nitrates, ammonium nitrites, alkali metal nitrites, and alkaline earth nitrites.

41. The admixture composition of claim 39, wherein the inorganic early set and strength accelerator comprises at least one of:
a) a thiocyanate salt of an alkali metal, alkaline earth metal, ammonium or aluminum;
b) an alkanolamine;
c) a thiosulphate salt of an alkali metal, an alkaline earth metal, ammonium or aluminum;
d) a hydroxide of an alkali metal, alkaline earth metal, or aluminum;
e) a carboxylic acid salt of an alkali metal, alkaline earth metal, or aluminum;
f) a polyhydroxylalkylamine; or
g) a halide salt of an alkali metal or alkaline earth metal.

42. The admixture composition of claim 39, wherein the organic set accelerator is at least one of methylolglycoluril, glycoluril, dimethylolurea, mono- and di(N-methylol) hydantoin, mono- and di(N-methylol) dimethylhydantoin, N-methylolacrylamide, tri(N-methylol) melamine, N-hydroxyethylpiperidine, N,N-bis(2-hydroxyethyl)piperazine, glutaraldehyde, pyruvaldehyde, furfural or water soluble urea-formaldehyde resins.

43. The admixture composition of claim 39 including alkaline earth nitrate, thiocyanate salt of an alkali metal, and glycoluril.

44. The admixture composition of claim 39 including calcium nitrate, sodium thiocyanate, and methylolglycoluril.

45. A cementitious composition comprising hydraulic cement and a cold weather admixture composition, said admixture composition comprising:
a) soluble inorganic salt having freezing point depressing properties;
b) inorganic early set and strength accelerator; and
c) a polycarboxylate high range water reducing dispersant;
wherein the high range water reducing dispersant is a polycarboxylate high range water reducing dispersant and has the general structure shown below: 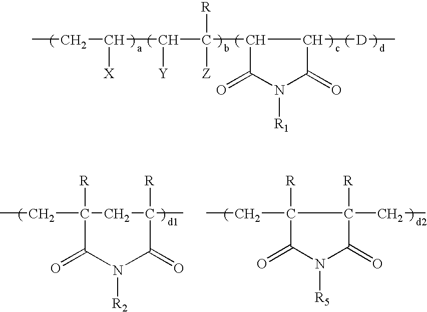
wherein in Formula (III):
D=a component selected from the group consisting of the structure d1, the structure d2, and mixtures thereof;
X=H, CH₃, C₂ to C₆ Alkyl, Phenyl, p-Methyl Phenyl, or Sulfonated Phenyl;
Y=H or —COOM;
R=H or CH₃;
Z=H, —SO₃M, —PO₃M, —COOM, —O(CH₂)ₙOR₃ where n=2 to 6, —COOR₃, or —(CH₂)ₙOR₃ where n=0 to 6, —CONHR₃, —CONHC(CH₃)₂ CH₂SO₃M, —COO(CHR₄)ₙOH where n=2 to 6, or —O(CH₂)ₙOR₄ wherein n=2 to 6;
R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;
R₄=H, Methyl, C₂ to about C₆ Alkyl, or about C₆ to about C₁₀ aryl;
M=H, Alkali Metal, Alkaline Earth Metal, Ammonium, Amine, triethanol amine, Methyl, or C₂ to about C₆ Alkyl;
a=0 to about 0.8;
b=about 0.2 to about 1.0;
C=0 to about 0.5;
d=0 to about 0.5; and
wherein a, b, c, and d represent the mole fraction of each unit and the sum of a, b, c, and d is 1.0; and
d) an organic set accelerator.

46. The cementitious composition of claim 45, wherein the soluble inorganic salt having freezing point depressing properties is at least one of ammonium nitrates, alkali metal nitrates, alkaline earth nitrates, ammonium nitrites, alkali metal nitrites, and alkaline earth nitrites.

47. The cementitious composition of claim 45, wherein the inorganic early set and strength accelerator comprises at least one of:
a) a thiocyanate salt of an alkali metal, alkaline earth metal, ammonium or aluminum;
b) an alkanolamine;
c) a thiosulphate salt of an alkali metal, an alkaline earth metal, ammonium or aluminum;
d) a hydroxide of an alkali metal, alkaline earth metal, or aluminum;
e) a carboxylic acid salt of an alkali metal, alkaline earth metal, or aluminum;
f) a polyhydroxylalkylamine; or
g) a halide salt of an alkali metal or alkaline earth metal.

48. The cementitious composition of claim 45, wherein the organic set accelerator is at least one of methylolglycoluril, glycoluril, dimethylolurea, mono- and di(N-methylol) hydantoin, mono- and di(N-methylol) dimethylhydantoin, N-methylolacrylamide, tri(N-methylol) melamine, N-hydroxyethylpiperidine,

49. The cementitious composition of claim 45 including alkaline earth nitrate, thiocyanate salt of an alkali metal, and glycoluril.

50. The cementitious composition of claim 45 including calcium nitrate, sodium thiocyanate, and methylolglycoluril.

51. A method of making a cementitious composition comprising forming a mixture of water, hydraulic cement and the cold weather admixture composition of claim 25.
